(19) United States
(12) Patent Application Publication
(10) Pub. No.: US 2011/0014897 A1
(43) Pub. Date: Jan. 20, 2011

(54) Mobile Social Networking

(75) Inventor: Rob Finucan, Manotick (CA)

Correspondence Address: PERLEY-ROBERTSON, HILL & MCDOUGALL LLP, 1400-340 Albert Street, OTTAWA, ON, K1R 0A5, CA

(73) Assignee: Dungolden Group Inc., Ottawa (CA)

(21) Appl. No.: 12/502,315

(22) Filed: Jul. 14, 2009

(51) Int. Cl. H04L 12/58; H04M 3/42; H04W 4/00; G06F 15/173

(52) U.S. Cl. 455/412.2; 455/414.1; 455/466; 709/223

(57) ABSTRACT

Social networking has become a significant aspect of many peoples lives as they communicate with others who are members of the same social networking application. In many instances members who have joined these social networks to find other individuals with similar interests are unaware that every day they are passing hundreds of people some of whom have these same interests but have not joined the same social network for reasons which may include embarrassment, unfamiliarity with computers, etc. Further full utilization of these social networks is really geared to users in front of their computers rather than their wireless devices which are with them most of the time. According to the invention users manage local profiles on their wireless devices which form ad-hoc networks with any other devices they encounter, exchange profile data to establish a degree of commonality or interests, and may meet during their normal daily lives.

### CROSS-REFERENCE TO RELATED APPLICATIONS

This application claims the benefit of priority to Canadian Patent Application filed Jul. 10, 2009 entitled “Mobile Social Networking” for which application serial number is currently unavailable.

### FIELD OF THE INVENTION

This invention relates to mobile social networking and more specifically to providing localized and remote profile based configuration of mobile devices associated with a user.

### BACKGROUND OF THE INVENTION

The Technology, Media and Telecommunications (TMT) business has grown in the past 10 years with the widespread deployment of wireless devices, personal computers, Internet, and broadband networks to represent a value chain of over $3 trillion worldwide, including content providers, advertisers, telecommunications companies and electronics suppliers (White Paper Wireless Social Networking from iSuppli, July 2008). In the next decade wireless social networking products, applications, components, and advertising will generate more than $2.5 trillion in revenue by 2020, according to iSuppli (Press Release, Jun. 4, 2008 http://www.isuppli.com/NewsDetail.aspx?ID=12930).

During the next decade it is anticipated that mobile devices, such as cellular telephones, smart phones, personal digital assistants (PDA), will become the primary channel for viewing content from or accessing the Internet (World Wide Web) for consumers and that social networking will have moved largely into the wireless realm providing the degree and type of ubiquitous connection that consumers demand. At the same time it is anticipated that this evolution with be accompanied by the creation of a new generation of applications that will greatly expand the appeal and utility of social networking, and will finally generate profits for the social networking industry.

It is anticipated that applications will have to be intuitive to consumers and enabled by innovative technologies, which will be introduced in the timeframe from 2009 to 2015 and accordingly spur the adoption of social networking as a feature of consumers everyday lives. Today there are essentially three levels of users, these being immediate family and close friends, extended friends, and shared interest groups. Today users interact sporadically, but intensely, with extended friends through games, avatars, and general updates and information. Users with common interests communicate in ways that extend into business. The popularity of social networking in business, for trading, online collaboration, and virtual meetings, is also likely to spur advancement of mobile devices equipped for content viewing and sharing.

Accordingly, as users move to such wireless devices as their primary means of communicating, accessing content, and using applications in the next decade, the technological innovations will also have to appear within the semiconductor and display industries globally. Increasingly displays will emerge as the most valuable portion of the mobile-device value chain, with makers of portable wireless devices stressing differentiation via superior display technology rather than features which have been important to date including battery lifetime, weight, size, full keyword, etc.

Accordingly display technologies, like touch screens, flexible displays, and motion sensors, will become increasingly important, while demand rises for highly integrated processors that combine numerous high-performance, multi-threaded special purpose cores as consumers expect performance in their wireless devices comparable to the dedicated special purpose processors they exploit today in gaming consoles, wireless devices, and personal computers. Additionally companies that supply the core silicon, microprocessors, graphics accelerators, memory, etc for these wireless social networking devices will increasingly need to balance software and firmware engineers alongside hardware engineers and semiconductor processing specialists.

These trends run against those experienced to date within the social networking arena where the focus has to date been on providing applications and building subscriber numbers and databases for applications where subscribers pay nothing and the enterprises building these hope to make a return from medium to long term strategies of offering enhanced services with fees or introducing advertising for example to generate revenue.

So if we consider a typical hypothetical social networking user of today then we find that they have both a personal computer (PC) and a smart phone, and that whilst their smart phone has a browser and they should be able to access most online sources that they can access from their PC, particularly those with wireless application protocol (WAP). However they do not use their smart phone as a computer, they use their PC for work or for anything that is a task requiring more than a couple of minutes. On the other hand they use their smart phone for short online tasks when on the move, limiting access time due to the subscriber plan they have with their service provider, such as Verizon™, AT&T™, T-Mobile™, BT™ etc. They will extend their access time if they are able to find a free wireless hotspot.

The hypothetical users computer social networking activities are based around writing emails, accessing social network sites such as Facebook™, Hi5™, LinkedIn™, Flickr™, Classmates™, Last™, MySpace™, Twitter™, Windows Live Spaces™, etc, where they read and comment on friends blogs, and upload pictures. A lot of these social networking sites are essentially passive, reading content, clicking here and there. Some social networking websites are more active, where they create and upload content, which will be read and seen by someone else. They also use other application such as Google Talk™, Windows Live Messenger™ and Skype™ for chatting. Their approach to instant messaging (IM) is usually simple: keeping IM turned on (with status online/busy) all the time they are at the computer and have long, informal conversations with whoever is online (one or more people). They will also access other applications such as YouTube or dating websites such as LavaLife, Yahoo Personals etc

However, we find that this hypothetical user has mobile phone social networking activities are very different from those above on the PC. They currently do not translate all their use from their PC to their mobile phone, mainly because the situations they are currently in and because their smart phone has a small screen not suitable for the majority of tasks they perform at the computer. For example PCs will typically have 17 inch through to 30 inch LCD displays and laptops ranging from 13 inch to 18 inch whereas typical smart phone displays are typically 1.9 inch or 2.2 inch and PDAs slightly larger at 2.4 inch, 2.5 inch or 2.8 inch.

Additional factors include memory, which is typically limited currently to 4 GB, 8 GB or 16 GB, e.g. Palm™ Centro™, LG™ Dare™, Blackberry™ Storm™ 9530, to store everything rather than 100s GB to Terabyte of hard disk drives (HDD) configured in many cases as RAID drives to store audio-visual content and typically 2 GB-4 GB of flash memory to handle immediate access requirements, reduced data transfer rates, absence of features such as copying, pasting, storing from the Internet, transfer to PC, and absence of applications with features that subscribers are used to such as text and graphics editors, spreadsheets, electronic mail applications etc. Whilst Microsoft™ Office™ is now available for specific devices such as Apple™ iPhone™ and Blackberry™.

As a result the hypothetical user obviously makes telephone calls, sends texts, and some electronic mail (email) but these emails will be generally shorter than their PC counterparts, and be replies rather than initiating emails or so-called push emails. They download Rich Site Summaries (RSS) with news, use Twitter™ (which limits postings to 140 characters), chat on Yahoo™ Messenger, Blackberry™ Messenger etc and in a limited percentage send direct messages with PIN-to-PIN messaging.

Another characteristic of mobile phone social networking with subscribers, and to a lesser extent computer social networking, is a trend to shifting social networking applications and a lack of retention from initial use. Even applications such as Facebook™ that work across both computer and mobile environments only achieve a 50% retention rate (Nielsen NetRatings Press Release May 2006, http://www.nielsen-online.com/pr/pr_{—}060511.pdf). Social networking applications such as Twitter™ which are currently causing substantial comments and being discussed as the new Facebook™, YouTube™ etc are only achieving retention rates of 40% (defined in users returning the following month from registering).

A common element to all these social networking applications, such as Facebook™, Hi5™, LinkedIn™, Flickr™, Classmates™, Last™, MySpace™, Twitter™, Windows Live Spaces™ etc is that the subscriber accesses a host website associated with the social networking application and generates a user profile which contains information relating to the subscriber which may include for example, sex, age, name, physical characteristics, likes, dislikes, email address and a photograph. They typically then generate a user name, which may be their real name, nickname, or a created name, and then a password allowing them to access the website and their personal profile securely. All of this information is hosted by servers associated with the social networking application and according to the specific social networking application may be searched fully or partially by another user of the social networking application who is seeking to find someone they know, have met, or would like to meet. Typically these search type functions are restricted to PC based access as the display functionality of the mobile devices is insufficient for effective use.

As a result mobile social networking tends to be more restricted than PC based social networking and tends to be restricted to emailing, adding simple messages (c.f. Twitter™), and being notified of adjustments in contacts information. Accordingly communications between two users of a social networking application would typically begin through at least one employing a PC to initiate the engagement, by performing a search, say for single females within the age range of 35 to 45 who live within 25 km of Ottawa, Ontario, Canada and have interests in ice hockey, baseball, good food and a looking for a long term relationship. Having the results of this search displayed on their PC they would typically initiate a communication to a selected user which may from that point on as it is a series of text based communications be that either within the mobile or PC domain.

However, whilst moving around Ottawa our male user who has registered perhaps with one, two, or more social networking applications in their search for a partner in a long term relationship will meet, pass or be within very close vicinity of a large number of potential partners without any inkling of the fact. If he has a superb memory he might recognize once in a while an individual if they posted a photograph of themselves to their profile but they may have wished to remain anonymous fearing social stigma from their friends, family, work colleagues etc if this search for a partner became public knowledge. This hesitation or reluctance increasing typically if their search is perhaps restricted to seeking someone for a short sexual liaison or for older subscribers who are less familiar with the social networking application or where they believe the people using the website are not honest, misrepresent themselves etc.

As a result our male user will only find potential partners who are registered with the social networking application. This may represent a very small fraction of the actual real world potential partners. Accordingly it would be beneficial to provide a social networking application that allowed a user to create a profile that was not solely hosted in a remote server requiring another user to login and search, but was stored locally to the user within a wireless device associated with them.

Additionally in many environments wireless communication between a users wireless device and the telecommunications network is interrupted due to service outage for example, they are outside coverage of their provider, or they are within a structure that limits coverage whilst when they are at the periphery of the structure or parts of it they have coverage. Examples of such buildings include office towers, do-it-yourself warehouses, and other retail outlets which are based primarily upon a metal shell. Further if the social networking application is going to be active for a large proportion of the time that the user is outside their residence then accessing the wireless telecommunications network constantly would be expensive and restrictive therefore to the users online time. Accordingly it would be beneficial if the social networking application engaged within communications that are undertaken without accessing the wireless telecommunications network or are undertaken in conjunction with the wireless telecommunications network.

It would also be beneficial if the subscriber was able to generate, adapt, and maintain their profile locally themselves, be that upon their personal PC or wireless device, and that these devices be locally synchronized so that whenever the subscriber departs their residence and elects to be active on the social networking application that their profile is up to date. It would be further beneficial if the local profile was synchronized to a remote hosted profile database for the social networking application such that the subscriber also benefits from the traditional benefits of the server based searchable social networking application.

Accordingly it is an intention for the invention to provide a social networking application wherein the user is able to leverage their wireless electronic devices to a greater extent than currently undertaken such that they are able to engage in social networking applications in a dynamic manner within their real time, real world environment rather than solely through a remote hosted database requiring other users to search and then contact the user. In this manner it is an intention of the invention to provide immediate direct interactions for users rather than indirect interactions undertaken over extended time periods.

### SUMMARY OF THE INVENTION

It is an object of the present invention to obviate or mitigate at least one disadvantage of the prior art.

In accordance with an embodiment of the invention there is provided a comprising providing a wireless device of a plurality of wireless devices, each wireless device comprising at least a memory and a transceiver, the transceiver operating according to at least a wireless standard and providing a local user profile, the local user profile being stored within the memory of the wireless device of a plurality of wireless devices and containing at least an element of data relating to a user of the wireless device of the plurality of wireless devices. The method further comprising establishing a communication from the wireless device of the plurality of wireless devices to another wireless device of the plurality of wireless devices, the communication being other than via at least one of a public switched telephone network and an Internet Protocol network and establishing a rating if a permission has been granted from the another wireless device of a plurality of wireless devices, the permission relating to the transfer of an element of data of a remote user profile, the remote user profile being the local user profile for a user of the another wireless device of the plurality of wireless devices.

In accordance with another embodiment of the invention there is provided a method comprising providing a wireless device of a plurality of wireless devices, each wireless device comprising at least a memory and a transceiver, the transceiver operating according to at least a wireless standard and providing a local user profile, the local user profile being stored within the memory of the wireless device of the plurality of wireless devices and containing at least an element of data relating to a user of the wireless device of the plurality of wireless devices. The method further comprising establishing a communication from the wireless device of the plurality of wireless devices to a local server associated with an enterprise, the communication being other than via at least one of a pubic switched telephone network and an Internet Protocol network and establishing a rating, the rating being established in dependence upon at least a predetermined portion of the local user profile temporarily stored within the local server and a predetermined portion of the database stored within the local server.

Other aspects and features of the present invention will become apparent to those ordinarily skilled in the art upon review of the following description of specific embodiments of the invention in conjunction with the accompanying figures.

### BRIEF DESCRIPTION OF THE DRAWINGS

Embodiments of the present invention will now be described, by way of example only, with reference to the attached Figures, wherein:

FIG. 1 depicts a network configuration according to the prior art for a social networking application;

FIG. 2 depicts a flow diagram for users accessing a social networking application according to the prior art;

FIG. 3 depicts an exemplary screen flow for a user accessing social networking applications upon their mobile telephone;

FIG. 4 depicts an exemplary environment for a localized social networking application according to an embodiment of the invention;

FIG. 5 depicts some typical environments wherein a localized social networking application according to the invention may be deployed;

FIG. 6A depicts exemplary displays for a user generating a profile with a social networking application according to an embodiment of the invention;

FIG. 6B depicts exemplary displays for a user configuring a social networking application according to an embodiment of the invention;

FIGS. 7A through 7D depict snapshots of a users dynamic ad-hoc environment for a social networking application according to an embodiment of the invention;

FIG. 7E depicts a cascaded ad-hoc environment for a social networking application according to an embodiment of the invention;

FIG. 8 depicts a first example of targeted advertising based upon a user of a social networking application according to an embodiment of the invention moving within range of a first store;

FIG. 9 depicts a second example of targeted advertising based upon a user of a social networking application according to an embodiment of the invention moving within range of a second store;

FIG. 10 depicts an example of a user of a social networking application according to an embodiment of the invention obtaining information regarding a local environment based upon their locally stored preferences within the social networking application;

FIG. 11 depicts an example of a user of a social networking application according to an embodiment of the invention obtaining information regarding people within a local environment based upon their locally stored preferences within the social networking application;

FIG. 12 depicts a flow chart for contact sequence according to an embodiment of the invention for social networking wherein the user engages another unknown individual using local wireless communications;

FIG. 13 depicts a flow chart for contact sequence according to an embodiment of the invention for social networking wherein the user engages another unknown individual using local wireless communications and requires the unknown individual to accept the contact; and

FIG. 14 depicts an example of a user of a social networking application in accordance with an embodiment of the invention wherein unique identifiers associated with the profiles of other users of the social networking application they wish to meet are retrieved and employed in identification of these users using local wireless communications.

### DETAILED DESCRIPTION

The present invention is directed to providing social networking between individuals wherein the initiation of contact is made through local wireless communications to locally stored preference data of the individuals rather than a centralized server based social networking environment.

Reference may be made below to specific elements, numbered in accordance with the attached figures. The discussion below should be taken to be exemplary in nature, and not as limiting of the scope of the present invention. The scope of the present invention is defined in the claims, and should not be considered as limited by the implementation details described below, which as one skilled in the art will appreciate, can be modified by replacing elements with equivalent functional elements.

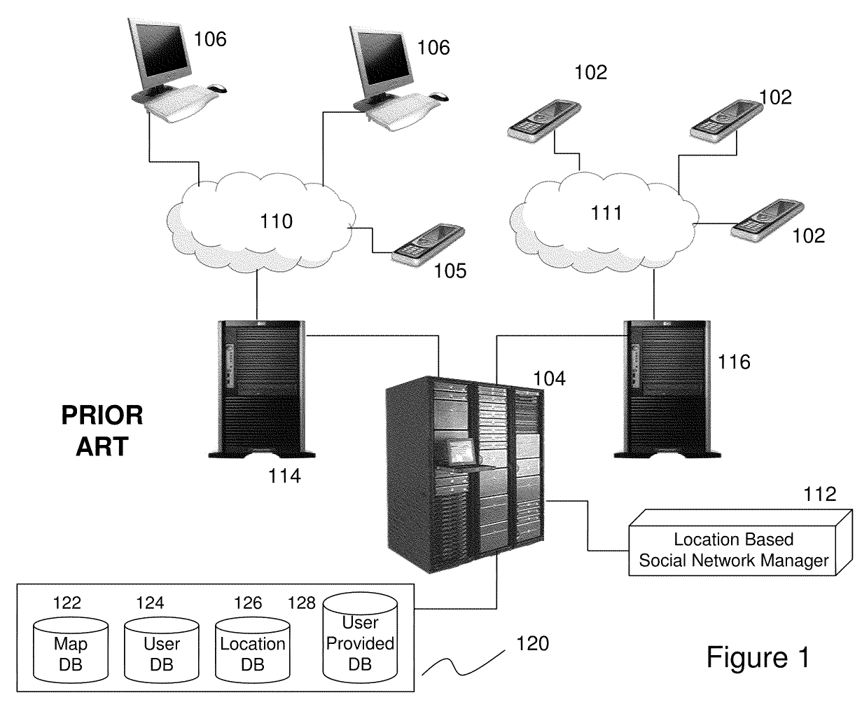

FIG. 1 depicts a network configuration 100 according to the prior art of S. H. Altman in US Patent Application 2007/0282621 entitled “Mobile Dating System Incorporating User Location Information” for a social networking application which employs a location based management module 112 in conjunction with a central server 104. As shown within the network configuration 100 there are a plurality of mobile users 102 who access a first network 110 and are coupled thereby to a first server 116 which supports the social networking application, for example Facebook™, Yahoo Personals™. Similarly a user 105 and desktop users 106 access a second network 111 through which they are coupled to a second server 114 which supports the social networking application. The first and second servers 116 and 114 respectively are local servers which are themselves connected to the central server 104.

The central server 104 being connected therein to a location based social network manager 112 and database server array 120 which contains map database server 122, user database server 124, location database server 126, and user provided database 128. The features of the location based social networking manager 112 advancing the network configuration 100 over the prior art to US Patent Application 2007/0282621 in that when a user, for example user 105, in accessing the social networking application to retrieve user information also retrieves map and location information as the location based social network manager 121 filters the retrieved search results based upon geographic location information of the user 105 and that of the other users extracted from the location database within the location database server 104. This geographic information being for example the cellular tower that the users 105 and 102 are currently accessing, as they are mobile, or the physical address of desktop users 106. However, in common with other social networking applications all information relating to users, their profiles, etc is stored within the servers and databases within the central server 104, database servers 120, and location based social network manager 112.

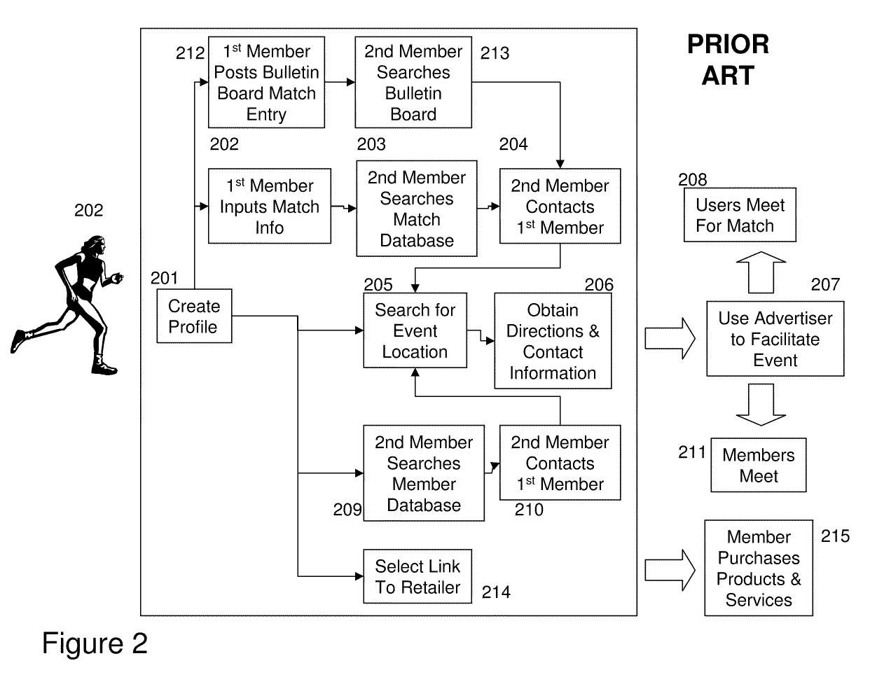

FIG. 2 depicts a flow diagram 200 for users accessing a social networking application according to the prior art, such as UltraFan™, SportsMates™ or SportsFanFinder™. The flow diagram 200 shown being according to the prior art of K. L. Zrike et al in US Patent Application 2007/0060328 entitled “Sports Matchmaker Systems”. Accordingly a first user 220 creates a profile at step 201 whereupon they have several options available to them. In one such option the first user 220 progresses to step 212 and posts an entry to a bulletin board for the time, location, teams etc relating to a football match in Toronto, Ontario, Canada. Subsequently another member at step 213 searches the bulletin board for football matches in Ontario, Canada and identifies the posting for the football match in Toronto. As such the second user then contacts the first user 220 at step 204 and then progresses in step 206 to search for the event location before obtaining directions and contact information for the event location.

In a second option the first user 220 posts match information into match database in step 220 which is subsequently searched by another user in step 203, identifies an event they are interested in and moves forward to step 206 wherein they contact the first member and the process flows as presented supra. In a third option the first user 220 having created their profile in step 201 moves to step 205 and searches for an event location at step 205 before moving to step 206 to obtain directions and contact information. In a fourth option a user having accessed the system searches the member database in step 209, identifies the first member 220 and contacts them in step 210 before moving to step 205 and searching for an event. In a fifth option the first user 220 having entered the system selects a link to an advertiser within the website in step 214 and leaves the social networking application to step 215 wherein they purchase products or services from the advertiser. As shown in FIG. 2 after members of the social networking application have progressed through the different options within the application then they move forward to other steps which include but are not limited to the users meeting for a match in step 208, members of the application meeting in step 211 and using an advertiser to facilitate the event in step 207.

In common with the social networking applications in the prior art as discussed supra in respect of FIG. 1 employs a centralized server to maintain the social networking application and the users login into this to perform the options outlined supra in respect of entering information, searching events etc.

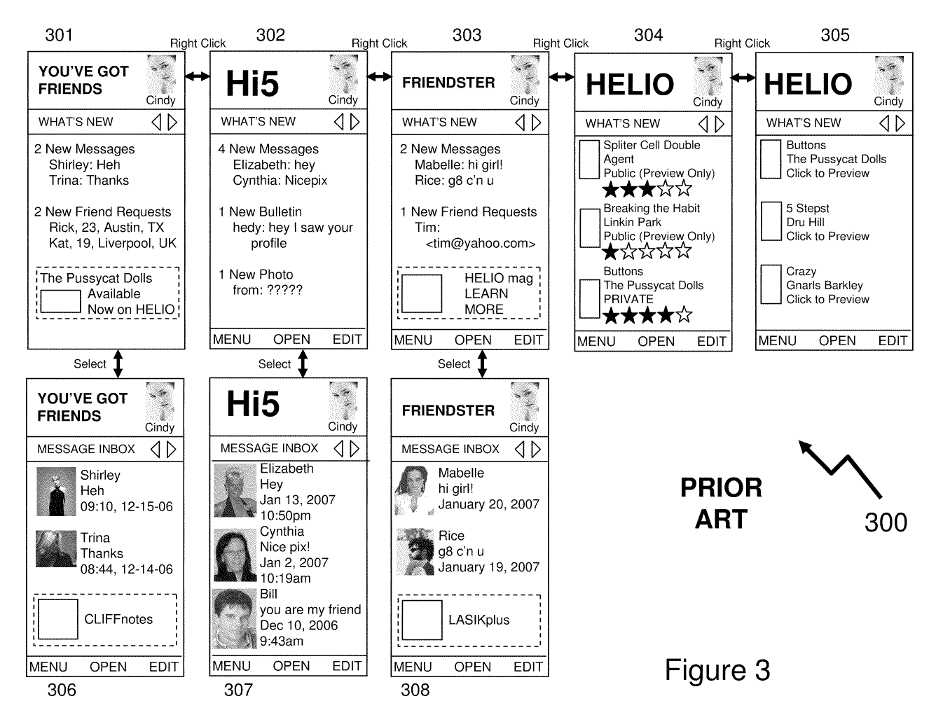

Now referring to FIG. 3 there is depicted an exemplary screen flow 300 for a user accessing social networking applications upon their mobile telephone. This exemplary screen flow 300 being according to the prior art of T. D. Wugofski et al in US Patent Application 2008/0182563 entitled “Method and System for Social Networking over Mobile Devices Using Profiles” and which relates t to a method of navigating rapidly between multiple social networking applications and exploiting premium services wherein users are rewarded in respect of other users viewing their premium profiles. As with other prior art social networking applications the users generate and maintain their standard and premium profiles within the servers of the company providing the social networking application. This access being through the wireless network of a telecommunications service provider such as Verizon™, AT&T™, Deutsche Telekom™ etc. However, Wugofski et al describe a method wherein the profile within one social networking application embeds links to other social networking applications that the user exploits or employs such that navigation and accessing these is eased against the prior art previous to Wugofski et al wherein a user would have to navigate out of one social networking application to another social networking application.

Accordingly exemplary screen flow 300 shows a user entering a first social networking application “MyYearBook” (www.myyearbook.com) in screen first 301 and by selecting an icon within first screen 301 and right clicking they move to another social networking application “Hi5” (www.hi5.com) in second screen 302. This selection in first screen 301 and right click automatically accessing the second social networking application and logging the user in such that these steps are eliminated speeding and simplifying the user experience. A right click within “Hi5” then moves the user to third screen 303 and a third social network application “Friendster” where again they are automatically logged into the social networking application. Again in third screen 303 the user scrolls down and selects an icon which with a right click moves them to a fourth social networking application “Helio” in fourth screen 304 (www.helio.com, Helios being acquired in June 2008 by Virgin Mobile). “Helio” as supplier of high-end smart phones incorporated multiple applications within their devices such as YouTube™ and Flickr™ and employed interfaces geared to such interfaces rather than wireless devices which are geared to other applications and then have the social networking application added subsequently by the user. From fourth screen 304 a right click within “Helio” moves the user from their music downloads to a list of new music.

Alternatively at the first screen 301 if the user elected to view their messages they would move to sixth screen 306 and see their new emails, together with a link at the bottom for “Cliffs Notes” which is a homework and free study guide website for students (www.cliffsnotes.com). Similarly within second screen 302 if the user selected to view their new messages they would be taken to seventh screen 307 and see their new emails, typically with an icon photo of their contact, their name, short title, and a date/time of receipt. The same functional movement within their social networking application being shown with movement from third screen 303 for “Friendster” to their email inbox within this social networking application as shown in eighth screen 308.

In all instances the user's mobile device accesses the different host servers of the multiple social networking applications and downloads the information to display the next screen. Such accessing always being via the wireless network to which the user's wireless device is connected.

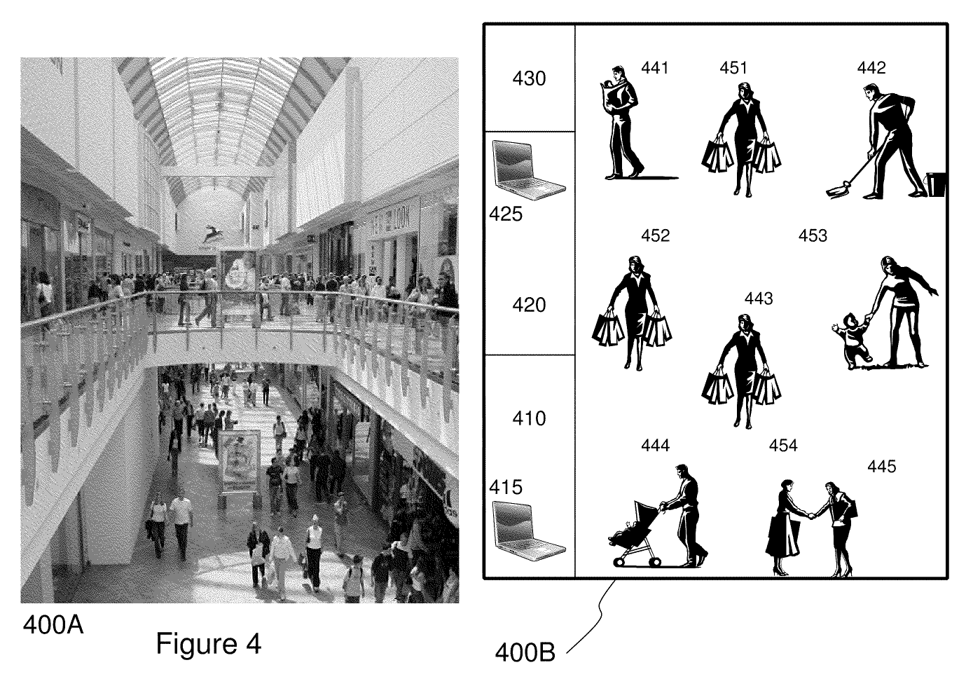

Referring to FIG. 4 there is depicts an exemplary environment 400A of a shopping centre or mall for a localized social networking application according to an embodiment of the invention. As shown schematically within mall segment 400B a plurality of users 441, 443, 444, 445, 451, 452, 453, and 454 are within the mall together with employees the mall and staff of the retail establishments, represented by worker 442. In today's connected society typically every one of the users 441, 443, 444, 445, 451, 452, 453, and 454 together with worker 443 will have a wireless device with them, be it a cellular telephone, personal digital assistant (PDA) etc. Additionally within the mall 400B are retail outlets 410, 420 and 430, two of which 410 and 420 respectively have wireless hubs 415 and 425 respectively within their stores. According to the prior art a user, such as user 451 who is female and seeking to meet another woman with interests in knitting for example, would join a social networking application, such as Knitting Network (www.knitting-network.com), create a profile and search for other members of Knitting Network within their local area to chat with an meet. Alternatively in the prior art they might have chanced in visiting a knitting shop, such as outlet 410, to meet someone else and strike up a conversation.

However, given that our user 451 may be in the store for only 5 minutes once a month when the store is open 9 am-8 pm 6 days a week and 12 pm to 5 pm Sundays, then the knitters of that local area using the outlet 410 will be distributed randomly with little overlap to our user 451. Hence, if unknown to user 451 two other users 452 and 454 who are within the mall 400B have just been or are about to go to the outlet 410 but are currently within the vicinity of the outlet 410, for example having a coffee or chatting with a friend 454, then user 451 would never have an opportunity to meet users 452 and 454 as neither are registered users with Knitting Network. However, if user 451 had a local profile stored within their wireless device (not shown for clarity) that included an interest in knitting and their wireless device communicated said interest list to other wireless devices within the vicinity of user 451, such as users 441, 452, 443, 453, 444, 454, 445 and worker 442, which upon receiving this list correlated the interests with those within locally stored profiles of each of the users 441, 452, 443, 453, 444, 454, 445 and worker 442, and then notified the respective users, such as users 452 and 454, where correlation was found then our user 451 might meet new contacts 452 and 454 either immediately or subsequently as each now knew of the others existence which would not have been possible with prior art social networking applications.

For example, the wireless devices of each of the users within the shopping centre 400B may, if provided with required functionality, communicate locally using Bluetooth™ whilst maintaining normal communications to the telecommunications network. Bluetooth™, which operates according to IEEE 802.15 standard, provides for ranges of approximately 1 meter (Class 3 transmitters), approximately 2.5 meters (Class 2 transmitters) and approximately 100 meters (Class 1 transmitters). Beneficially Bluetooth™ would also communicate to users with laptops rather than cellular telephones, and mobile gaming consoles such as Nintendo DSi™. Additionally it would be evident that the device which the user contains the local personal profile within and communicates locally with other devices through for example Bluetooth™ may be a discrete device not connected to any other networks.

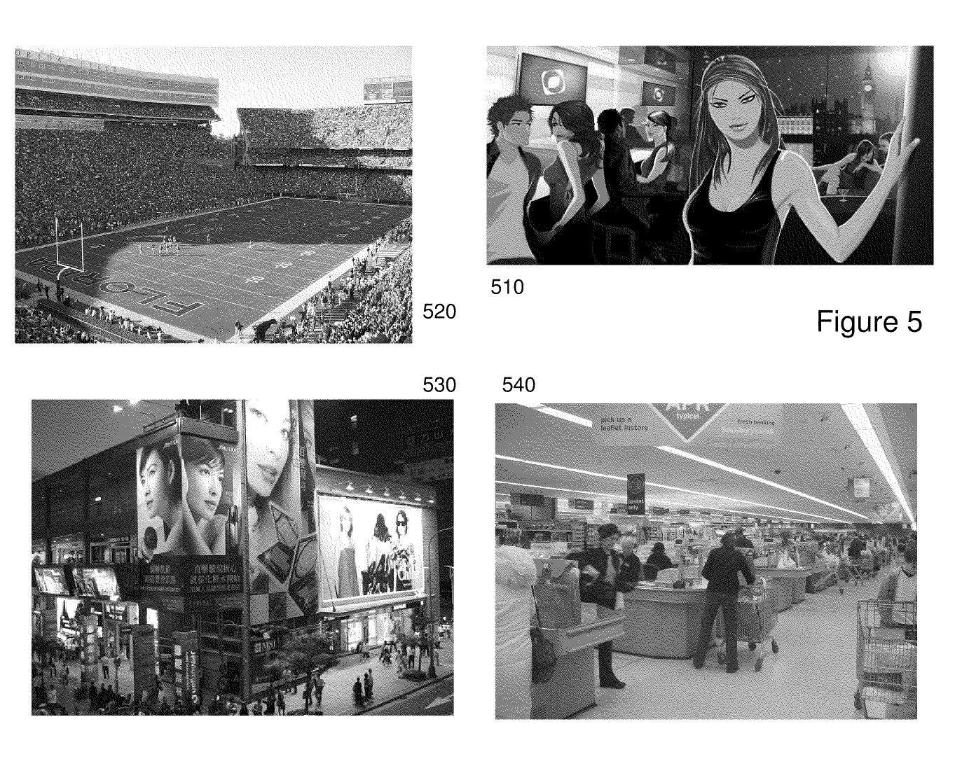

Referring to FIG. 5 there are depicted some typical environments wherein a localized social networking application according to the invention may be deployed outside of the shopping centre, which include a sports arena 520, nightclub 510, cinema complex 530 and supermarket 540. It would be evident to one skilled in the art that the localized environment wherein a social networking application according to an embodiment of the invention may be employed is potentially anywhere the user goes as they will be passing, meeting, around, and within proximity to people all the time.

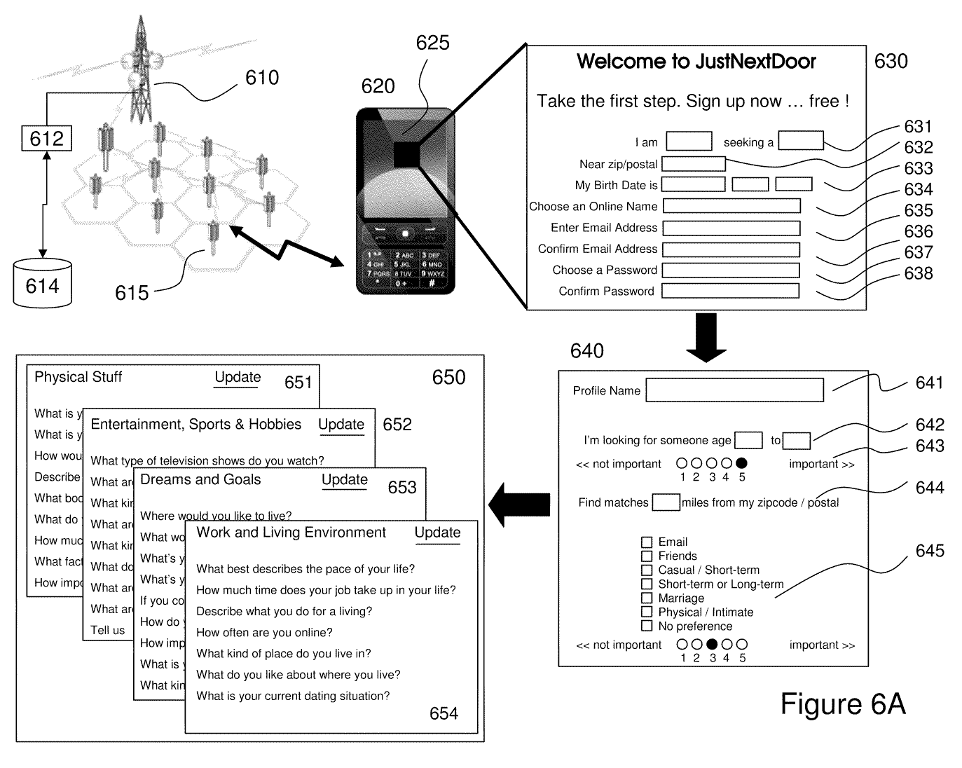

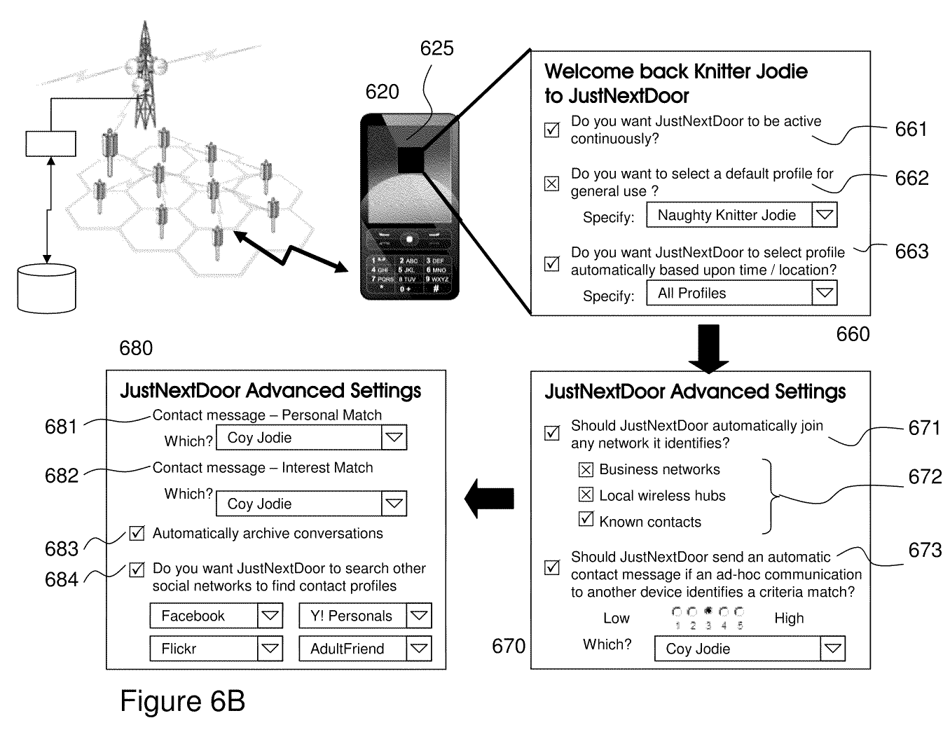

FIG. 6A depicts an exemplary display sequence for a user generating a profile with a social networking application according to an embodiment of the invention. The user, not shown for clarity, possess wireless device 620 and has remotely downloaded a new social networking application “JustNextDoor” from the server 614 of “JustNextDoor Inc” which is connected to the wireless device 620 via telecom network 612 to base station 610 and femtocell 615. Having downloaded “JustNextDoor” an icon 625 is displayed upon the wireless device 620. Upon selecting icon 625 the first time the application enters at screen 630 for the user to generate a local profile. As such the user is asked to define in this example if they are a man/woman seeking a man/woman/either in entry field 631, their residential postal code or another post code that typifies their location in line 632, date of birth in line 633, online name in line 634 such as “Knitter Jodie”, enter an email address in line 635, verify the email address in line 636, choose a password in line 637, and verify the password in line 638.

Having completed screen 630 the user moves forward to second screen 640 wherein they are prompted to enter additional information including entering a profile title, for example “Looking for Friends to Knit With” in line 641, establish an ideal age range in line 642, attach an importance level to the age range in line 643, specify a radius within which the contacts should live in line 644, and establish one or more types of relationship they are seeking in line 645. From screen 640 the user may continue to third screen 650, exit and return or perform other options within the software. However, in progressing to third screen 650 the user is prompted through a series of forms 651 through 654 to enter information regarding themselves which may relate to for example physical in first form 651, entertainment/sports/hobbies in second form 652, dreams and goals in third form 653 and work/living environment 654. This information forming the basis by which “JustNextDoor” establishes a potential match to another user by seeking correlations in activities, interests, etc with respect to sex, age, location etc.

It would be apparent to one skilled in the art that alternatively the forms 651 through 654 may be simple fields for population by the user with interests, activities, aspects of potential contacts that are important etc. It would be evident to one skilled in the art that many methods of populating the social networking application with the appropriate data exist without departing from the spirit of the invention.

It would also be evident that rather than downloading the “JustNextDoor” social networking application from the network that it may have been provided for example as a default application on the users wireless device, have been downloaded from a server automatically or in a number of other manners known to one of skill in the art.

Now referring to FIG. 6B there are depicted further exemplary displays for a user configuring a social networking application such as “JustNextDoor” which is accessed via icon 625 on their wireless device 620 according to an embodiment of the invention. Accordingly in first screen 660 the user “Knitter Jodie” is welcomed back and prompted to enter some configuration data, which for example includes:
“Do you want JustNextDoor to be active continuously?” with tick box 661 which determines how the user wishes to use “JustNextDoor”, and where crossing the box may have presented other options such as to limit the applications activity to evenings, daytime, weekends, only when selected by user etc;
“Do you want to select a default profile for general use?” with tick box 662 which allows a user to select a default profile or select a specific one, which in this case is “Naughty Knitter Jodie” and may relate to a profile that is more focused to dating than hobbies etc; and
“Do you want JustNextDoor to select profile automatically based upon time/location?” with tick box 663 which in this case has been enabled and hence may determine to use a business profile during weekdays as “Business”, evenings “Friends”, but may adapt during weekdays from “Business” to “Dating” for example if the device hosting the local personal profile and “JustNextDoor” determines that the user has entered a bar, shopping centre, etc.

In second screen 670 the user is now asked to determine characteristics of the networks to which their device employing “JustNextDoor” may join, as during their movements they may encounter a variety of different networks that are compatible with their wireless device, be it solely Bluetooth™ or additionally WiFi (IEEE 802.11), WiMAX (IEEE 802.16), etc. As such in line 671 the user is prompted to determine whether such automatic connections should be made and if selected “yes” as shown which networks should then be connected to in group 672 wherein options include for example “business networks”, “local wireless hubs” and “known contacts”. Then in line 673 the user is asked to determine whether they wish to send an automatic contact message if a criteria, or multiple criteria, of interest are matched, along with a degree of matching from low through to high, and which automatic contact message. In this case the user has selected “Coy Jodie” from their available automatic messages. In the scenario that the user decided not to select an automatic message for example the application may highlight that a match exists and give the user the chance to enter a message directly at that time.

If the user elects to use some advanced settings, shown for example by third screen 680 then they may be presented with options such as providing a specific contact message reference where the match relates to personal preferences, in line 681, providing a contact message reference where the match relates to an interest in line 682, determining whether “JustNextDoor” automatically archive conversations in line 683, and determining whether “JustNextDoor” in addition to sending direct messages to identified contacts should search other social networking applications for contacts profiles related to the contact identified in line 684. If the user elects yes then they are prompted to enter which social networking applications to search, this search potentially being very specific if the returned contact information from the contact is detailed in respect of age, location, interests, name etc.

Accordingly the user may obtain information relating to the contact from multiple social networking applications. Such information may it would be apparent to a person of skill in the art may be presented in many formats which range from presenting the profiles of each social networking application individually through to presenting a table comparing the information on the multiple websites, for example for inconsistencies or missing information. Many formats may be employed without departing from the scope of the invention.

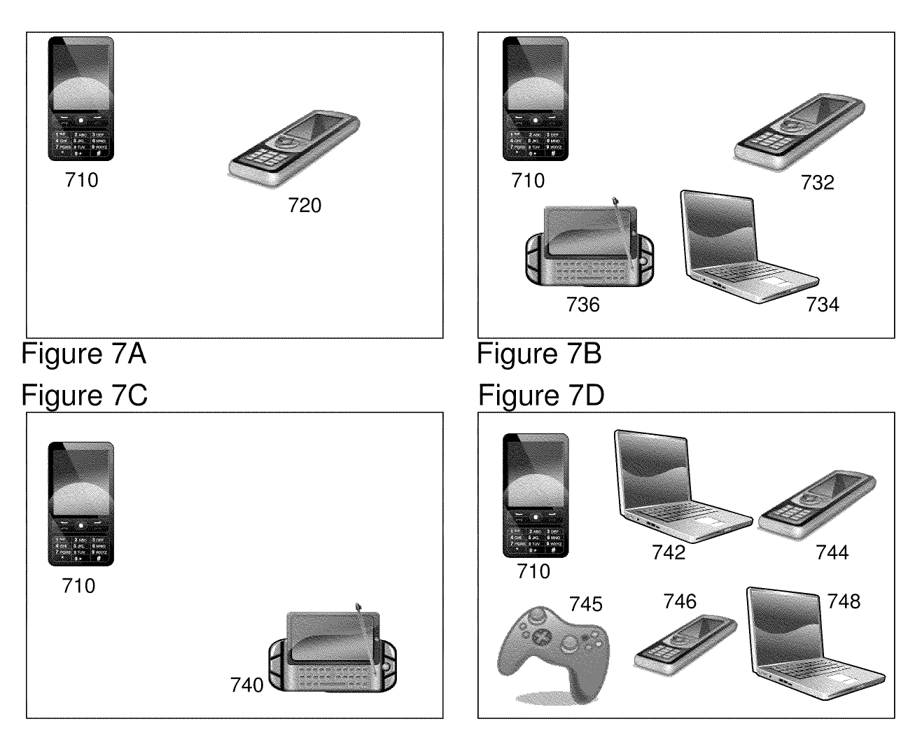

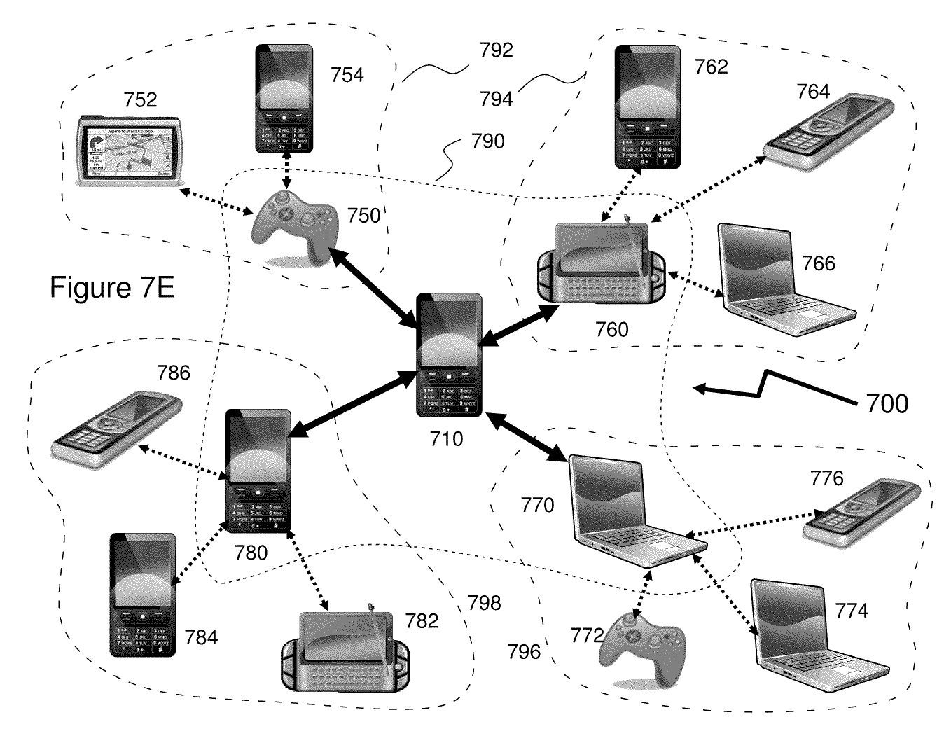

As discussed supra in respect of FIGS. 4, 5, 6A and 6B a user with a local broadcast profile in a social networking application may encounter individuals, organizations, etc in different configurations as these individuals and user are moving within their normal activities which bring them into range of the wireless communications. Similarly an individual stationary within for example a coffee shop may similarly encounter a varying network of individuals as customers enter, queue, stay and depart. Such a varying environment is presented in respect of FIGS. 7A through 7D which depict snapshots of a user's dynamic ad-hoc environment for a social networking application according to an embodiment of the invention. In first snapshot of FIG. 7A the user, with their wireless device 710 encounters a first user with their wireless device 720, which may be a cellular telephone for example. Subsequently, in second snapshot in FIG. 7B the user's wireless device 710 is in communication with a second wireless device 732, a laptop 734, and a smart phone 736. In some circumstances second wireless device 732 and first laptop 734 may be associated with the same user and each may contain their local social profile. The user associated with second wireless device 732 and laptop 734 departs leaving the user's wireless device 710 in communication with smart phone 740 in third snapshot of FIG. 7C. At a later point in time the user is in a different location and now their wireless device 710 is in communication with third and fourth wireless devices 744 and 746 respectively, second and third laptops 742 and 748 respectively, and gaming console 745. Accordingly the user's wireless device 710 supports the formation of ad-hoc networks with the other devices within its vicinity.

Referring to FIG. 7E there is depicted a cascaded ad-hoc environment 700 for a social networking application according to an embodiment of the invention. As shown a wireless device 710 belonging to a user of a social network application according to an embodiment of the invention is part of an ad-hoc network 790 with four users who are represented by their first through fourth wireless ad-hoc network devices 750 through 780 respectively. However, each of these four users are themselves part of other ad-hoc networks with users of the social networking application. Hence, for example first wireless ad-hoc network device 750 is part of a second ad-hoc network 792 comprising devices 752 and 754 respectively. Similarly second wireless ad-hoc network device 760 is part of a second ad-hoc network 794 comprising devices 762, 764, and 766 respectively, third wireless ad-hoc network device 770 is part of a third ad-hoc network 796 comprising devices 772, 774, and 776 respectively. Finally fourth wireless ad-hoc network device 780 is part of a fourth ad-hoc network 798 comprising devices 782, 784, and 786 respectively

It would be apparent to one skilled in the art that as each of the wireless ad-hoc network devices 750 through 780 has retrieved local profiles from the members of each respective ad0ho9c network 792 through 798 respectively that these profiles may be transferred to the wireless device 710. Accordingly the user possessing wireless device 710 may retrieve a large number of local profiles from other users by exploiting this cascaded ad-hoc network approach. It would be evident that this may be extended further to a third level or more, wherein devices within one of the ad-hoc networks such as device 766 are themselves part of another ad-hoc network. Further it would be apparent that the depth of this cascaded tree of ad-hoc networks may be limited to a predetermined number of levels or dynamically adjusted according to some measure of the density of the devices 710 through to 786 respectively. For example within a shopping centre, sports arena etc many ad-hoc networks may cover a very limited geographic area, particularly if there is a limit to the number of devices within an ad-hoc network from the wireless protocol exploited, for example a Bluetooth™ piconet may be the master (e.g. wireless device 710) and eight active slaves (such as ad-hoc network devices 750 though 790), or up to 255 “parked” slaves. In other situations the number of levels may be low as the geographic distribution is large, for example users within vehicles etc.

It would be apparent to one skilled in the art that rather than loading and storing profiles from other users that the wireless device may retrieve unique serial numbers associated with the other users, these unique serial numbers having been provided to the other users from the social networking application with which they have registered. The user may then access the social networking application and retrieve using these unique serial numbers the local user profiles of the other users in order to perform the comparison against their own local user profile. Alternatively the user may provide these unique serial numbers to the social networking application which then performs the comparison and advises the user of the results. Optionally the social networking application contacts the other user to inform them that the user is present locally to them with a profile matching theirs to a predetermined extent.

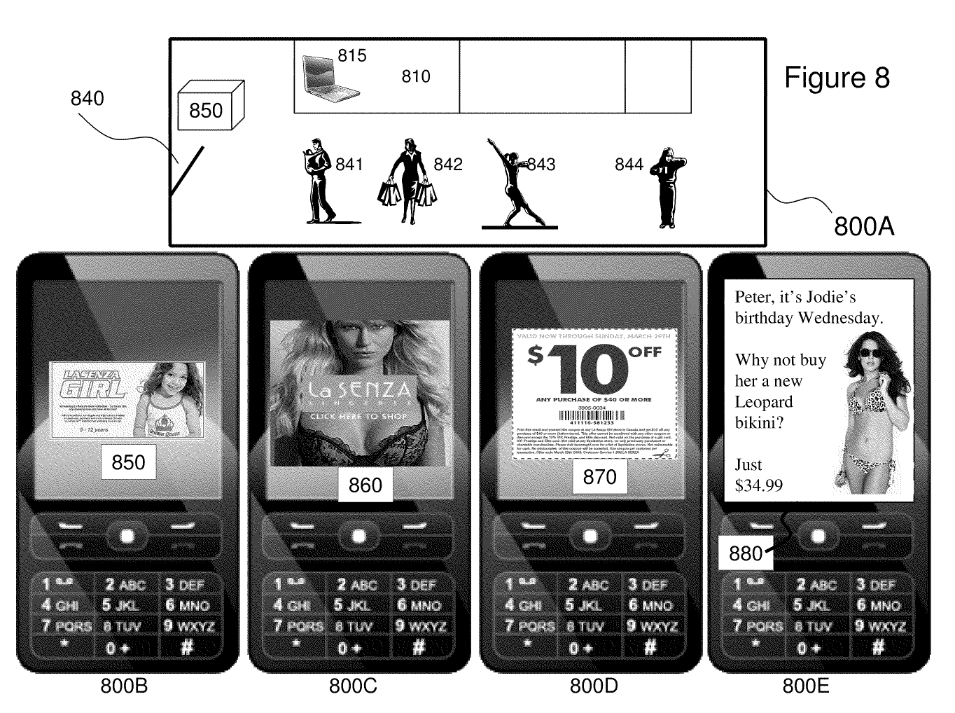

In the embodiments presented supra the social networking application has been presented in respect of users identifying others with similar interests and overlapping profiles through the formation of ad-hoc networks between devices associated with the users that store these local profiles. However, in other scenarios these personal profiles may be employed in adaptive targeted information presentation or advertising. For example referring to FIG. 8 there is depicted a first example of targeted advertising based upon a user of a social networking application according to an embodiment of the invention moving within range of a first store 810 of a shopping centre 800A. Within the shopping centre 800A are first through fourth users 841 to 844 respectively, who entered the shopping centre 800A through doorway 840. In doing so each of their wireless devices formed an ad-hoc network with a gateway 850 associated with the shopping centre 800A and containing information provided by either the shopping centre 800A itself or first through third stores 810 to 830 respectively.

In this exemplary example first store 810 being “La Senza” (www.lasenza.com) has loaded targeted advertising to the gateway 850 from a store computer 815. When fourth user 844 entered the shopping centre 800A their personal profile identified them as an 11 year old girl and according onto their wireless device 800B a first advertisement 850 was loaded and presented to the fourth user, this first advertisement relating to “La Senza Girl” (www.lasenzagirl.com) a line of clothing for girls aged 5-12 years old. Next first user 841 enters the shopping mall 800A and their personal profile was transferred from their wireless device 800C to the gateway 850 identifying them as a 35 year old married male. As a result a second advertisement 860 is loaded to their wireless device 800C. This advertisement may relate to a specific product offer available at that time, e.g. sale of sleepwear, Valentines Day, Christmas etc.

Next second user 842 enters the shopping mall 800A and their personal profile was transferred from their wireless device 800D to the gateway 850 identifying them as a 45 year old single female who is actively seeking a partner. As a result a third advertisement 870 is loaded to their wireless device 800D. This advertisement may relate to a specific product offer available at that time, e.g. the $10 discount on any purchase over $40, a special offer on lingerie etc. Then third user 843 enters the shopping mall 800A and their personal profile is transferred from their wireless device to the gateway 850 identifying them as a 14 year old female teenager, for whom first store 810 has determined that it has no offers it wishes to make at this point in time and hence they are not presented with any advertisement.

It would be apparent that the targeted advertising may be very specific, such as in the case of first user 841 wherein the gateway extracts that the first user's 841 partner has a birthday on July 5^{th}, that today is July 3^{rd}, and thereby prompts first user 841 with a specific advertisement 880 which prompts with the text “Peter, it's Jodie's birthday Wednesday. Why not buy her a new Leopard bikini? Just $34.99” and displays a photograph of the item in question. Further the gateway may have identified from the personal information has a bust measurement of 36C, the first user storing this information so that he does not buy the wrong size presents for his partner, and that the store has not got the Leopard bikini in the advertisement in that size at that point in time. Accordingly it might replace the Leopard bikini with a red polka dot bikini instead.

It would be apparent to one skilled in the art that the advertisements, information transferred to the users wireless devices may be customized based upon the user's personal profile but also in dependence upon other factors such as time of day, location of the store, date, external weather conditions, etc. Hence, a store may offer the user a special deal on breakfast if they enter the mall between 9 am and 11 am before switching to another offer later in the day.

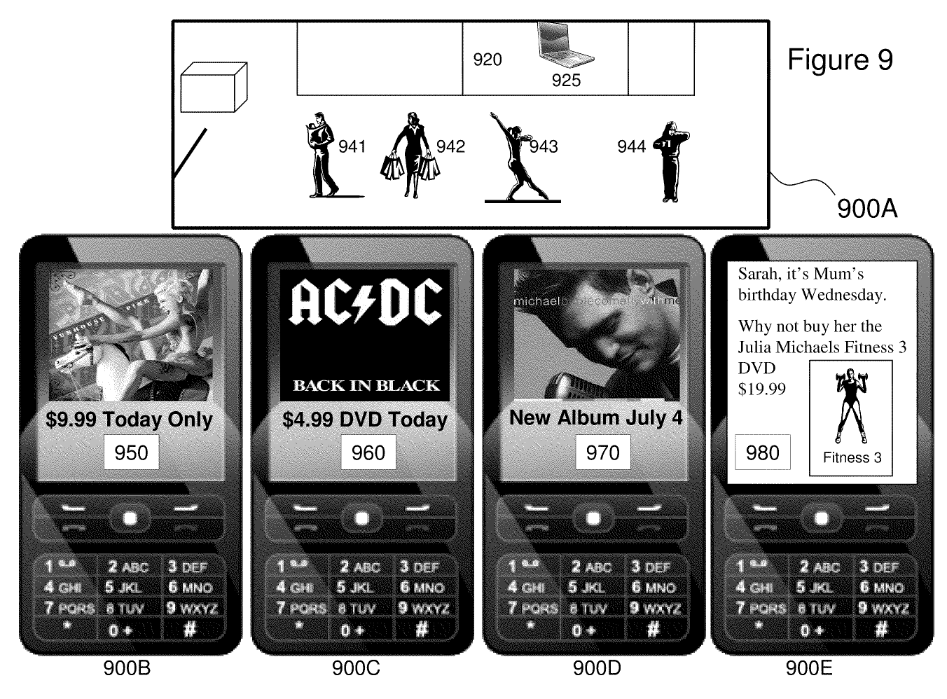

Further the advertisements may be provided to the wireless devices of the users upon entry into the mall or alternatively at subsequent points within the mall. It would also be apparent that the advertising may be provided direct to the users from the store computer 815 and not via the gateway 850 without departing from the scope of the invention as depicted in FIG. 9. Referring to FIG. 9 there is depicted a second example of targeted advertising based upon a user of a social networking application according to an embodiment of the invention moving within range of a second store 920 within a mall 900 wherein first through fourth users 941 through 944 come within range of a store 920 having a social networking application compatible with that of the first through fourth users 941 through 944 respectively loaded onto the store computer 925. Accordingly fourth user 944 has her wireless device 900B form an ad-hoc network with store computer 925 wherein the local personal profile is transferred identifying her as an 11 year old girl whereupon the store computer 925 transfers a first advertisement 950 to her wireless device 900B, this being an advertisement for a music release by the artist “Pink”. Next first user 941 has their wireless device 900C form an ad-hoc network with the store computer 925, which establishes from their local personal profile that they are a 35 year old married man with an interest in rock music and transfers second advertisement 960 to their wireless device 900C, this being a special offer on the album “Back in Black” from the group “AC/DC”.

Now third user 943 has their wireless device 900D form an ad-hoc network with the store computer 925, which establishes from their local personal profile that they are a 45 year old single female with an interest in male solo artists and transfers third advertisement 970 to their wireless device 900D, this being a notification that a new album from the artist “Michael Buble” will be released July 4^{th} Finally fourth user 943 in walking along the mall towards second store 920 has their wireless device 900E form an ad-hoc network with the store computer 925 and transfers their local personal profile to the store computer 925. This identifies that the user 943 is “Sarah”, she is 15 years old, and that her mother's birthday is July 5^{th}. As today is July 3^{rd} the store computer transfers a fourth advertisement to their wireless device 900E with the message “Sarah, it's Mum's birthday Wednesday. Why not buy her the Julia Michaels Fitness 3 DVD $19.99” along with an image of the cover of the “Fitness 3” DVD.

It would be apparent to one skilled in the art that the advertising or notifications transferred to the users may be extended to include additional features or links. For example, the specific advertisement 880 of FIG. 8 or the second advertisement 960 of FIG. 9 may include an icon allowing the user to order the item such that when they arrive at the store the item they wish to purchase has been retrieved from inventory as is awaiting their collection at the sales counter. As the social networking application has retrieved the local personal profile of the user it will have details regarding them such as full name allowing potential issues at the sales counter to be resolved as each user would be able to provide identifying information matching that taken from their local personal profile. The user may be able to select a time for collection so that they have time to perform other tasks and be confident the store has had sufficient time to retrieve the item. Alternatively the user may select a particular size of garment; colour etc and the information transferred to the store computer for correlation to the store inventory records so that the user does not make a wasted trip to the store.

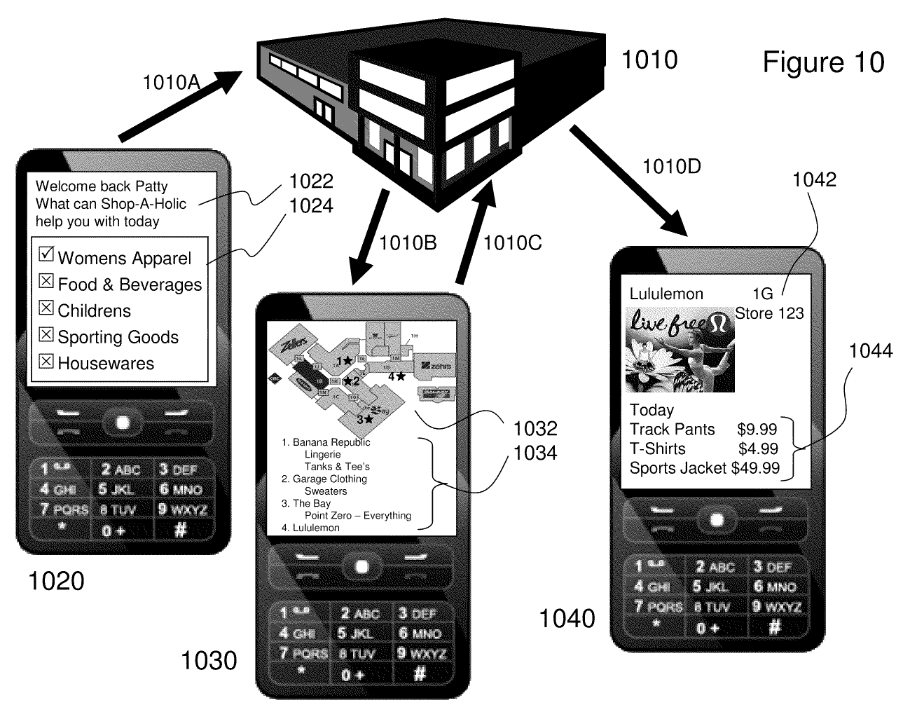

Now referring to FIG. 10 there is depicted an example of a user of a social networking application according to an embodiment of the invention obtaining information regarding a local environment based upon their locally stored preferences within the social networking application. Accordingly the user, not shown for clarity has entered a shopping centre 1010 which via a gateway terminal, not shown for clarity but for example gateway 850 of FIG. 8 supra, triggers a social network application to be started upon the users wireless device. This application being “Shop-A-Holic” which prompts a first configuration 1020 of their wireless device with a prompt screen featuring a greeting 1022 “Welcome back Patty. What can Shop-A-Holic help you with today” and a list of areas of retailers which has been pre-populated with interests in list 1024 which have been determined in dependence upon the local personal profile of the user. For example if the user is a 25 year old single female then the application has pre-populated the list 1024 with only women's apparel as of interest. The user is able to adjust this or proceed with the pre-populated selections.

The users list 1024 is communicated to a gateway terminal in message 1010A which is processed and prompts return message 1010B from the gateway and prompts a second configuration 1030 of their wireless device that presents the user with a map 1032 of the shopping centre and a list of special offers 1034 which are presented based upon matching the local personal profile of the user to information provided by the retailers to the gateway. As such the user is presented with offers from four stores being, “Banana Republic”, “Garage Clothing”, “The Bay” and “Lululemon”. Against each are listed either brands or items of apparel the retailers wish to promote and the stores locations upon the map 1032. The user can then select a store, for example “Lululemon”, which triggers message 1010C to the gateway whereupon the gateway retrieves the data stored for “Lululemon” which prompts a third configuration 1040 of their wireless device which includes store location 1042 and a list of special offers 1044.

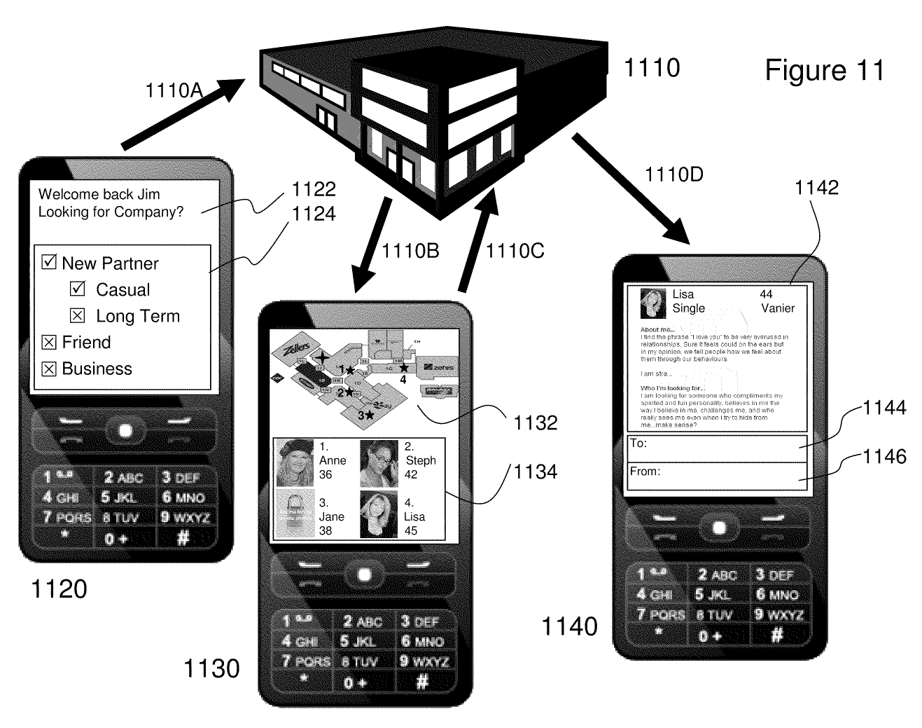

Referring to FIG. 11 there is depicted an example of a user of a social networking application according to an embodiment of the invention obtaining information regarding individuals within a local environment based upon their locally stored preferences within the social networking application. Accordingly the user, not shown for clarity has entered a shopping centre 1110 which via a gateway terminal, not shown for clarity but for example gateway 850 of FIG. 8 supra, triggers a social network application to be started upon the users wireless device. This application being “Shop-A-Holic” which prompts a first configuration 1120 of their wireless device with a prompt screen featuring a greeting 1122 “Welcome back Jim. Looking for Company” and a list of areas of options which has been pre-populated with interests in list 1124 which have been determined in dependence upon the local personal profile of the user. For example Jim is a 30 year old single male and the application has pre-populated the list 1124 with the option of “New Partner—Casual Interest” The user is able to adjust this or proceed with the pre-populated selections.

The users list 1124 is communicated to a gateway terminal in message 1110A which is processed and prompts return message 1110B from the gateway and prompts a second configuration 1130 of their wireless device that presents the user with a map 1132 of the shopping centre and a list of women 1134 currently in the mall who have local personal profiles that have been read by the gateway and have profiles that contain personal information and preferences that correlate to the user. As such the user is presented with short details of four women, “Anne 36”, “Steph 42”, “Jane 38”, and “Lisa 45”. Against each where available are shown photographs of these women stored within the gateway whilst the users within the mall. Approximate locations of the women are shown upon the map 1132. The user can then select one profile, “Lisa 45”, which triggers message 1110C to the gateway whereupon the gateway retrieves the data stored for “Lisa 45” which prompts a third configuration 1140 of their wireless device which displays additional information from the personal profile 1142 and includes messaging fields “To:” 1144 and “From:” 1146. From that point the user may communicate with “Lisa 45” and potentially meet within the mall and start a relationship.

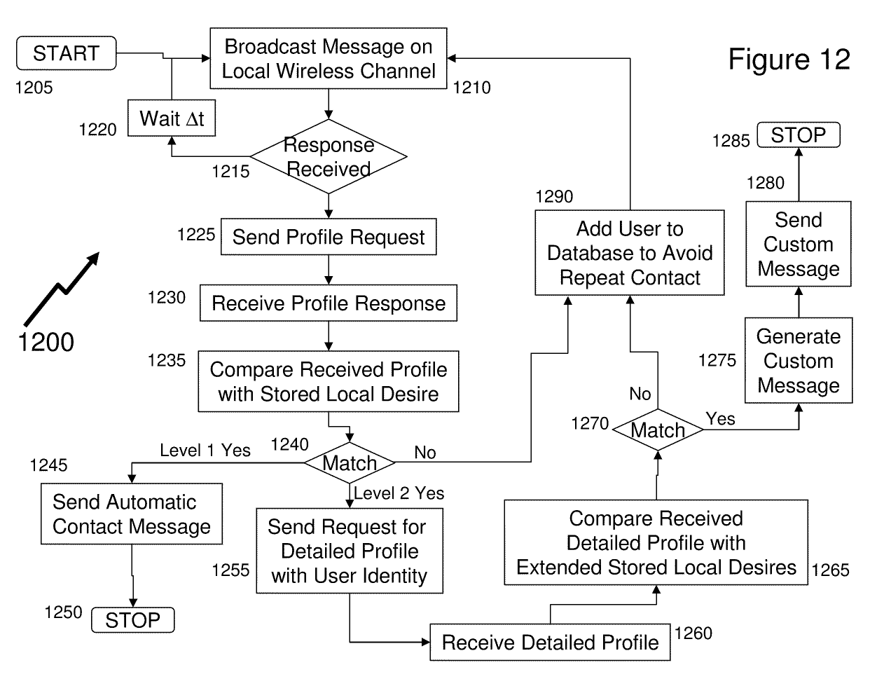

Referring to FIG. 12 there is depicted a flow chart 1200 for a contact sequence according to an embodiment of the invention for social networking wherein the user engages another unknown individual using local wireless communications. The process begins with step 1205 and moves to step 1210 wherein the user's wireless device broadcasts upon a local wireless channel, such as Bluetooth™ for example, and checks in step 1215 if another device has responded. If not the process moves to step 1220 waits for a predetermined period of time and then returns to step 1210. If, however, another wireless device utilizing the application and similarly broadcasting receives the broadcast from the users device it will change its broadcast message to an acknowledgement which is received by the user's device causing the check at step 1215 to be positive and the process moves to step 1225 wherein the users device sends a request to receive the local personal profile from the other users device.

Next at step 1230 the user's device receives the profile from the other user and then in step 1235 compares this received profile with the stored local desires of the user, i.e. their preferences. Next in step 1240 it is determined whether a match has been made. If the determination is no then the process moves to step 1290 and updates a database within the user's wireless device so that next time the other user is identified the user device determines this and does not initiate contact. This aspect of the process flow having been omitted for the sake of clarity in FIG. 12. If the match is partially made to a first predetermined level then the process moves to step 1245 and an automatic contact message is sent to the other user and the process moves in this exemplary embodiment to a stop at step 1250. If a match above a second predetermined level is achieved then the process flow moves to step 1255 and a request is send to the other user device for a detailed profile. In step 1255 this detailed profile is received from the other user's device in step 1260 and compared in step 1265 whereupon in step 1270 the process forks according to the determination in step 1265.

If the match for the detailed profile comparison does not exceed a second predetermined threshold the process moves forward to step 1290 and updates the database identifying the contact as someone not to be contacted again. If the second predetermined threshold is exceeded the process moves to step 1275 giving the user the option to send a custom generated message to the other user which is then sent in step 1280 to the other user and the processes moves to a stop in step 1285.

It would be apparent to one skilled in the art that the determination of the match may be established in a variety of manners such as for example an overall score, a weighted score where particular preferences are multiplied according to user determined weightings, and by particular subject. Optionally after the automatic contact message has been sent in step 1245 the process may continue to a conversational mode with the other user if they respond. Similarly after match 1270 and the match does not exceed the second predetermined threshold then a second automatic message may be sent or the user is still given the chance to send a custom message but is aware of the lack of the threshold being met.

It would be further evident to one skilled in the art that an alternative configuration for the process flow would be for the user having established contact with the other user to send their local personal profile to the other users device and to receive a response from the other user device as to whether the other user wishes to be contacted. In this alternative configuration potential concerns of users in releasing their profile may be allayed as they do not release their profile. Alternatively users of the social networking application may define themselves as initiators, i.e. those sending local personal profile information out for comparison in determining whether a contact should be initiated, or as determinators, i.e. those who receive a local personal profile from another individual and determined whether a contact should be initiated.

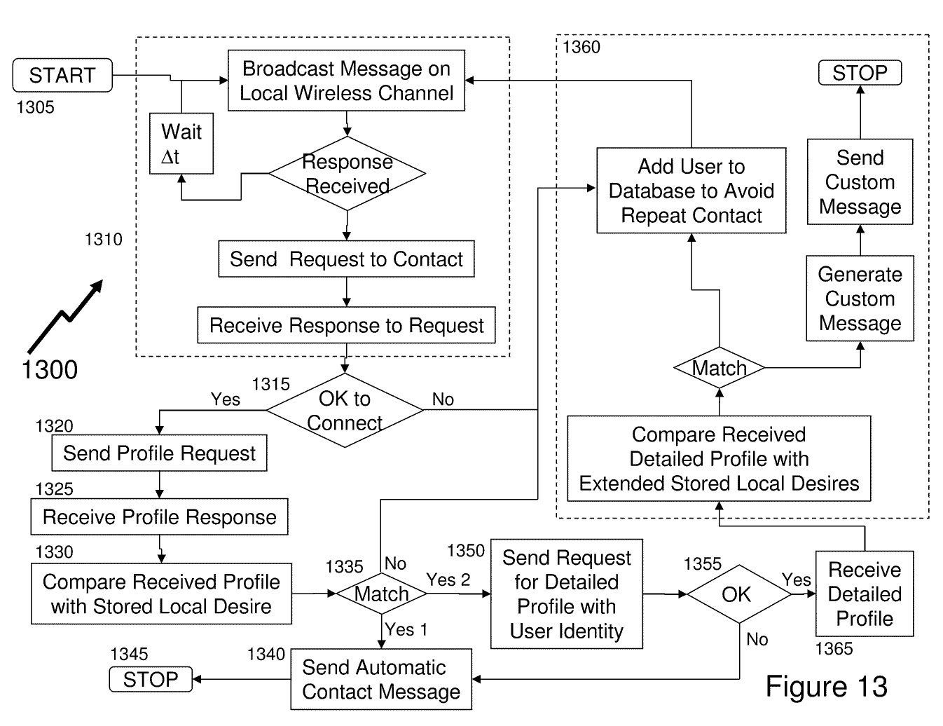

Now referring to FIG. 13 depicts a flow chart 1300 for a contact sequence according to an embodiment of the invention for social networking wherein the user engages another unknown individual using local wireless communications and requires the unknown individual to accept the contact. The process begins in step 1305 and moves to process block 1310 wherein the user's device determines whether another device is present and polls the other device. The process then moves to step 1315 wherein the other user has indicated to the user whether it is acceptable to connect to the other user. If the determination in step 1315 then the process moves to second process block 1360 updates a database of contacted users and returns to process block 1310.

If the determination is positive, i.e. e other user accepts the request to connect then in step 1320 a request is sent to the other wireless device for the local personal profile of the other user, which is then sent and received in step 1325. Next in step 1330 this local personal profile of the other user is compared with the local personal profile of the user to establish an overlap in interests, wishes/desires, characteristics etc. In step 1335 the result of this comparison is used to determine a course of action, which if the result is that the comparison fails to meet a predetermined criterion the process against moves to second process block 1360, updates the local database of the user and returns to process block 1310. If the comparison meets a first predetermined threshold level but fails to exceed a second predetermined threshold level then the process moves to step 1340, sends an automatic contact message and then moves to terminate at step 1345. If the comparison exceeds both the first and second predetermined thresholds then the process moves to step 1350 wherein a request for a detailed profile transfer is send to the other user.

In step 1355 the other user determines whether to grant this second request for the detailed personal profile, which may for example now include more personal information such as for example their name, more detailed physical characteristics, expanded and/or more detailed desires, characteristics etc. If this request is denied then the process moves to step 1340 and the automatic contact message is sent to the other user and the process moves to step 1345. If the result of the determination in step 1355 is an acceptance by the other user of the request for the detailed personal profile then the process moves forward to second process block 1360 where the received detailed profile is compared with the user profile and if a match occurs the user establishes and sends a custom message. The steps in second process block being comparable to steps 1270 through 1290 in FIG. 12.

It would be evident that the contact message automatically sent in step 1340 may alternatively be a selected one of a plurality of contact messages, the selected one being determined in dependence of the correlation between the users local personal profile and the other users local personal profile, either as an overall correlation or based upon specific aspects of the profile correlation/overlap.

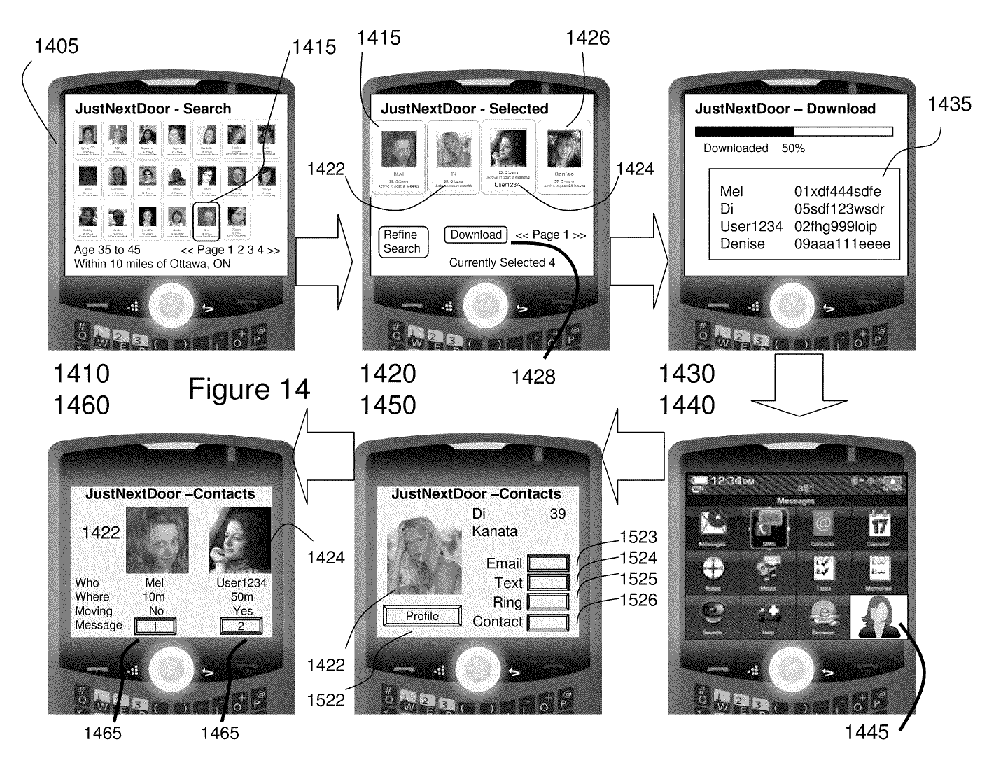

Now referring to FIG. 14 there is depicted an example of a user of a social networking application in accordance with an embodiment of the invention wherein unique identifiers associated with the profiles of other users of the social networking application they wish to meet are retrieved and employed in identification of these users using local wireless communications. As shown in first display 1410 a user on their wireless device 1405 has accessed a social networking application “JustNextDoor” and had displayed results for their search, for females within the age range 35 to 45 living within 10 miles of Ottawa, Ontario, Canada. Of these one, “Mel” 1415, has been highlighted as a contact the user would like to meet. This page of contacts being 1 of 4 for display.

In the second display 1420 the user has now moved from the search screens such as first display 1410 to selected mode wherein they are presented with only the contacts they selected and options to refine the search and download. The screen also showing they have only selected 4, being “Mel” 1415, “Di” 1422, “User1234” 1424, and “Diane” 1426. “User1234” 1426 having not entered a name in creating their profile has been assigned one by the social networking application. If the user then wishes to download the profiles then they select button 1428 and the download process begins as shown in third display 1430. Accordingly the user is provided with a status display and the social networking application downloads to the user's wireless device the information 1435 necessary for the identification of the selected other users of the social networking application. The information 1435 being shown by way of example only as this would normally be hidden from the user.

As shown the information comprises unique identifiers, then being “O1xdf444sdfe” for “Mel” 1415, “05sdf123wsdr” for “Di” 1422, “02fhg9991oip” for “User1234” 1424 and “09aaa111eeee” for “Diane” 1426. Upon completion of the download the social networking application is exited by the user resulting in fourth display 1440 which is the normal display of the applications on the wireless device associated with the user and includes “JustNextDoor” 1445. Now the user goes about their normal business, going to work, shopping, going to entertainment events etc and the social networking application operates in background establishing temporary ah-hoc communications with other wireless devices and extracting their unique identifiers to compare with those stored in their wireless device. These unique identifiers for the other wireless devices being present for those having registered with the social networking application and completed their profiles for example wherein they were provided to them electronically or by another means for entry into their wireless device.

Next in fifth display 1450 one potential contact display is presented when the user encounters another wireless device with a stored unique identifier that matches one of those downloaded. In the fifth display 1450 the user is presented with a photo of “Di” 1422 together with her age “39”, information regarding her home “Kanata”, a button to review her profile 1522 and four buttons 1523 through 1526 with contact methods for “Di” 1422. These being “Email” 1523, “Text” 1524, “Ring” 1525, and “Contact” 1525 respectively. The necessary information for these methods having been retrieved from the social networking application and stored securely associated with the user's unique identities. In this manner the user may contact the other user by conventional means “Email” 1523, “Text” 1524, and “Ring” 1525, or elect to contact them through the social networking application with “Contact” 1525.

In sixth display 1460 a second potential contact display is presented wherein two contacts are displayed being “Mel” 1415 and “User1234” 1424 along with approximate separation from the user and buttons 1465 to contact the users. Selecting a button 1465 results in the users standard contact message being sent to the other user. Beneficially the method presented within FIG. 14 supra reduces the amount of information that must be transferred between wireless devices to establish the local social networking.

Optionally, when the match of unique identity is made the user's wireless device may relay a message to the other user's wireless device triggering a message such as “A user of JustNextDoor who is interested in meeting you is now close by and may contact you”.

It would be apparent that whilst the above embodiments have been presented in some aspects with respect to providing a dating or matchmaking type service the invention may be employed in a variety of other applications. Examples of such applications include conferences, tradeshows, tours, cruises, etc.

The above-described embodiments of the present invention are intended to be examples only. Alterations, modifications and variations may be effected to the particular embodiments by those of skill in the art without departing from the scope of the invention, which is defined solely by the claims appended hereto.

What is claimed is:

1. A method comprising:
(a) providing a wireless device of a plurality of wireless devices, each wireless device comprising at least a memory and a transceiver, the transceiver operating according to at least a wireless standard;
(b) providing a local user profile, the local user profile being stored within the memory of the wireless device of a plurality of wireless devices and containing at least an element of data relating to a user of the wireless device of the plurality of wireless devices;
(c) establishing a communication from the wireless device of the plurality of wireless devices to another wireless device of the plurality of wireless devices, the communication being other than via at least one of a public switched telephone network and an Internet Protocol network;
(d) establishing a rating if a permission has been granted from the another wireless device of a plurality of wireless devices, the permission relating to the transfer of an element of data of a remote user profile, the remote user profile being the local user profile for a user of the another wireless device of the plurality of wireless devices.

2. A method according to claim 1 wherein;
providing the at least an element of data comprises providing data relating to at least one of an aspect of, an interest of, a characteristic of, a desire of, a wish of, an activity of, and information of the user of the wireless device of the plurality of wireless devices.

3. A method according to claim 1 wherein;
providing the at least an element of data comprises providing data relating to at least one of a profile of the user of the another wireless device of the plurality of wireless devices associated with a social networking application, a unique identifier provided by a social networking application associated with a profile of the user of the another wireless device of the plurality of wireless devices on the social networking application, and a unique serial number associated with the another wireless device of the plurality of wireless devices provided to a social networking application when the user creates a profile on the social networking application.

4. A method according to claim 1 wherein;
at least one of steps (b), (c) and (d) are controlled by an application in execution upon the wireless device of the plurality of wireless devices.

5. A method according to claim 4 wherein;
the application in execution automatically performs the at least one of step (c) and (d).

6. A method according to claim 1 further comprising;
(e) at least one of notifying the user of the wireless device of the plurality of wireless devices and sending a contact message to the user of the another wireless device of the plurality of wireless devices, the at least one of determined in dependence upon at least the rating and a predetermined criterion.

7. A method according to claim 6 wherein;
notifying the user of the wireless device of the plurality of wireless devices comprises notifying the user in a manner determined in dependence upon at least the rating and predetermined criterion.

8. A method according to claim 6 wherein;
sending a contact message comprises selecting the contact message from the plurality of contact messages and transmitting the contact message to the another wireless device of the plurality of wireless devices via the established link.

9. A method according to claim 1 wherein;
step (c) further comprises establishing communications with an ad-hoc network of a predetermined portion of the plurality of wireless devices, the predetermined portion of the plurality of wireless devices comprising at least the another wireless device of the plurality of wireless devices.

10. A method according to claim 1 wherein;
step (d) comprises establishing the rating in dependence upon at least one of a first predetermined portion of the local user profile and a predetermined portion of the remote user profile.

11. A method according to claim 10 further comprising;
(e) establishing a second rating, the second rating being determined in dependence upon at least one of a second predetermined portion of the local user profile and a second predetermined portion of the remote user profile.

12. A method according to claim 11 wherein;
the second predetermined portion of the remote user profile is retrieved from the another wireless device of the plurality of wireless devices if at least one of the rating determined in step (d) meets a predetermined criterion and a permission being granted by the user of the another wireless device of the plurality of wireless devices.

13. A method according to claim 1 wherein;
permission is granted by the user of the wireless device of the plurality of wireless devices in dependence upon at least one of a request being received by the user of the another wireless device of the plurality of wireless devices from the user of the wireless device of the plurality of wireless devices and a predetermined portion of the local user profile being transmitted to the another wireless device of the plurality of wireless devices.

14. A method according to claim 1 wherein;
step (d) is performed upon the another wireless device of the plurality of wireless devices.

15. A method according to claim 14 wherein;
the rating is at least one of communication to the wireless device of the plurality of wireless devices

16. A method comprising:
(a) providing a wireless device of a plurality of wireless devices, each wireless device comprising at least a memory and a transceiver, the transceiver operating according to at least a wireless standard;
(b) providing a local user profile, the local user profile being stored within the memory of the wireless device of the plurality of wireless devices and containing at least an element of data relating to a user of the wireless device of the plurality of wireless devices;
(c) establishing a communication from the wireless device of the plurality of wireless devices to a local server associated with an enterprise, the communication being other than via at least one of a pubic switched telephone network and an Internet Protocol network;
(d) establishing a rating, the rating being established in dependence upon at least a predetermined portion of the local user profile temporarily stored within the local server and a predetermined portion of the database stored within the local server.

17. A method according to claim 16 wherein;
the database comprises data relating to at least one of an aspect of the enterprise.

18. A method according to claim 17 wherein;
the aspect of the enterprise is at least one of a product, a retailer, an offer to sell, an employee of the enterprise, a service, and a location.

19. A method according to claim 16 wherein;
the database comprises a predetermined portion of another local user profile, the another local user profile associated with another wireless device of the plurality of wireless devices having performed at least step (c) of claim 16.

20. A method according to claim 16 wherein;
step (c) is performed within a predetermined location with respect to the enterprise.

21. A method according to claim 16 wherein;
the local server removes information from the database in dependence upon at least one of an update from the enterprise, a predetermined time, an indication a user associated with the wireless device of the plurality of wireless devices is no longer within a predetermined location with respect to the enterprise, and an indication that another user associated with another wireless device of the plurality of wireless devices is no longer within a predetermined location with respect to the enterprise.

22. A method according to claim 20 wherein;
the information removed comprises the local user profile associated with the at least one of the wireless device of the plurality of wireless devices and the another wireless device of the plurality of wireless devices.

23. A method according to claim 16 further comprising:
(e) notifying the user of the wireless device of the plurality of wireless devices when the rating exceeds a predetermined criterion.

24. A method according to claim 19 wherein;
the predetermined portion of another local user profile comprises data relating to at least one of an aspect of, an interest of, a characteristic of, a desire of, a wish of, an activity of, and information of the user of the another wireless device of the plurality of wireless devices.

25. A method according to claim 19 wherein;
the predetermined portion of another local user profile comprises data relating to at least one of a profile of the user of the another wireless device of the plurality of wireless devices associated with a social networking application, a unique identifier provided by a social networking application associated with a profile of the user of the another wireless device of the plurality of wireless devices on the social networking application, and a unique serial number associated with the another wireless device of the plurality of wireless devices provided to a social networking application when the user creates a profile on the social networking application.
